(19) United States
(12) Patent Application Publication
(10) Pub. No.: US 2006/0160494 A1
(43) Pub. Date: Jul. 20, 2006

(54) Simple communication apparatus

(76) Inventor: Steve Waldner, Lauder (CA)

Correspondence Address: ADE & COMPANY INC., P.O. BOX 28006 1795 HENDERSON HIGHWAY, WINNIPEG, MB, R2G1P0, CA

(21) Appl. No.: 11/326,579

(22) Filed: Jan. 6, 2006

Related U.S. Application Data
(60) Provisional application No. 60/644,016, filed on Jan. 18, 2005.

(51) Int. Cl. H04B 1/38

(52) U.S. Cl. 455/90.3

(57) ABSTRACT

A communication apparatus features a transmitter unit and a separate receiver unit for communication between the locations thereof. The transmitter unit features a control switch used to select from one of multiple directions. A display on the receiver unit displays one of the directions when selected on the transmitter unit by means of the control switch. The apparatus allows easily understood, language independent, directional instructions to be transmitted from a first location to a second location, for example between separate vehicles in which the units are mounted.

This application claims under 35 U.S.C. 119 the filing date of Provisional Application No. 60/644,016 filed Jan. 18, 2005.

This invention relates to a simple communication apparatus for example for simple but clear communications of instructions between a first control person in a first vehicle and a second person in a second vehicle for purposes of assisting the operator of the second vehicle to move to required locations relative to the first vehicle.

### BACKGROUND OF THE INVENTION

The requirement with which the present invention is concerned is that of allowing the operator of a first vehicle to easily and effectively communicate with the driver of the second vehicle to move to required positions relative to the first vehicle. This is particularly required when the first vehicle, such as a harvesting machine, is required to unload crop material into the second vehicle, such as a transport truck, while both are moving. Often the driver of the first vehicle can better see the location of the load of the crop material and can best direct the unloading into the required locations on the second vehicle to balance the load. This requires the driver of the second vehicle to move forwards or backwards or side to side relative to the first vehicle so that the fixed discharge spout unloads to required positions in the truck. Also the second driver must be instructed to move away and depart when loading is complete.

Commonly two way radio is used for this purpose but this has difficulties of clarity and interference when more than one harvesting device is operating in a locale so that the wrong driver may receive intended instructions and may be confused leading to discharge of valuable cops onto the ground.

In U.S. Pat. No. 3,866,269 of Haglund published Feb. 11^{th} 1975 is disclosed a device for signalling between a towing vehicle and a towed vehicle which includes an indicator in the towed vehicle which acts to inform the driver of the second or towed vehicle the intended direction of movement. This device uses wire communication which is unsuitable for unconnected vehicles where one of the vehicles is intended to move to a different location and the control and display systems are inconvenient for communication of the information.

In US published application 2004/0004544 of Knutson published Jan. 8^{th} 2004 is disclosed a device for communicating from a first vehicle to a second vehicle so that a driver of the first vehicle can direct the driver of the second vehicle to move to required locations for unloading of the first vehicle into the second vehicle. Knutson proposes an arrangement for this purpose but the design has a number of deficiencies which have limited its acceptance in the field.

### SUMMARY OF THE INVENTION

It is one object of the invention to provide a simple communication system which is inexpensive and provides simple clear instructions to a person at the receiver as to actions which are required.

According to one aspect of the invention there is provided a communication apparatus comprising:

a transmitting unit comprising:

a housing which can be readily moved from site to site;

a control switch on the housing having a plurality of different directions which can be selected by the operator;

a transmitter for transmitting a signal indicative of a direction selected;

and a separate receiving unit comprising:

a housing which can be readily moved from site to site for location at a receiving site different from the transmitting unit;

a receiver for receiving the transmitted signal;

and a display on the housing responsive to operation of the control switch and having a plurality of different directions which can be displayed such that when the operator selects one of the directions and operates the control switch accordingly the respective direction is displayed on the display for viewing by a person at the receiving site.

Preferably the control switch and the display have four directions which are forward, backward, left side and right side.

Preferably the display is illuminated.

Preferably the display is formed of a plurality of LEDs arranged in an array to define the directions.

Preferably the array includes a central set of LEDs.

Preferably the transmitter includes a first button and a second button which are operable separately from the control switch and which provide operation of the display different from each other and different from the direction display.

Preferably the first button indicates STOP and the second button indicates GO.

Preferably the receiver includes a beeper.

Preferably the sole output of the receiver is the display of the directions and the buttons and the beeper.

According to a second aspect of the invention there is provided a method of providing communications of instructions between a first control person at an observation site and a second person at an operating site comprising:

providing at the observation site a transmitting unit comprising:

a housing which can be readily moved from site to site;

a control switch on the housing having a plurality of different directions which are selected by the operator depending on observations at the observation site;

a transmitter for transmitting a signal indicative of a direction selected;

and providing at the operating site a separate receiving unit comprising:

a housing which can be readily moved from site to site for location at a receiving site different from the transmitting unit;

a receiver for receiving the transmitted signal;

and a display on the housing responsive to operation of the control switch and having a plurality of different directions which can be displayed such that when the operator selects one of the directions and operates the control switch accordingly the respective direction is displayed on the display for viewing by a person at the operating site thus providing simple directional instruction to that person.

### BRIEF DESCRIPTION OF THE DRAWINGS

One embodiment of the invention will now be described in conjunction with the accompanying drawings in which:

FIG. 1 is a top plan view of a transmitter unit of an apparatus according to the present invention.

FIG. 2 is an isometric view of a transmitter unit of an apparatus according to the present invention.

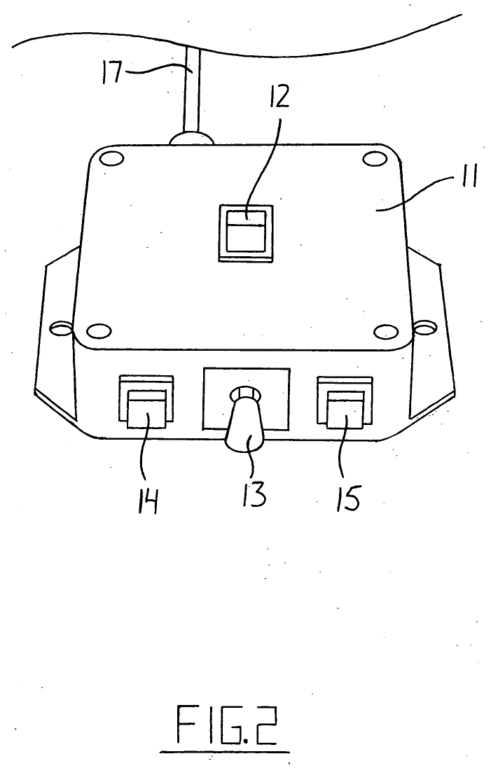

FIG. 3 is a top plan view of a receiving unit of the apparatus according to the present invention.

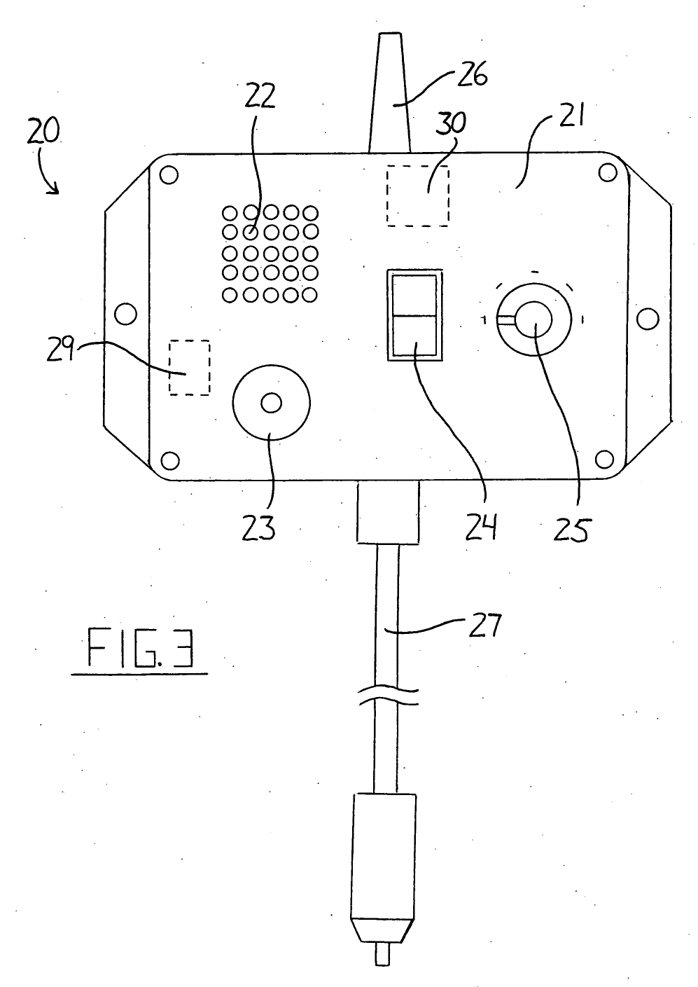

In the drawings like characters of reference indicate corresponding parts in the different figures.

### DETAILED DESCRIPTION

The apparatus shown provides a simple form of wireless, wordless communication between operators of two different pieces of equipment. An example would be a potato harvester, and the truck alongside it. In this operation, for example, it is crucial that the truck is loaded as efficiently as possible. The truck operator, however, is often unable to see into the box being loaded, and, ultimately, has to be instructed by the harvester operator whether to move the truck forward or stay farther back; or whether to move closer to the harvester or farther away, to provide for the most efficiently piled load.

The Communicator consists of at least one transmitter unit, affixed, in this example, in the potato harvester; and one receiver unit, affixed, in this example, in the truck. The transmitter unit 10 consists of a box 11 with an on/off switch 12, a joystick (four-way switch) 13 and two buttons 14, 15. One of the buttons 14 forms a STOP switch. The other 15 forms a FULL switch. The receiver unit 20 consists of a box 21 with an array of lights 22, a beeper 23, power switch 24, channel selector dial 25 and a small antenna 26. The units are plugged by a cable 17 and 27 into a cigarette lighter for power.

The array of lights includes a block of twenty-five LED lights which alight to display arrows corresponding to directions indicated by the joystick. The beeper 23 emits a distinct sound for each of the four possible directions.

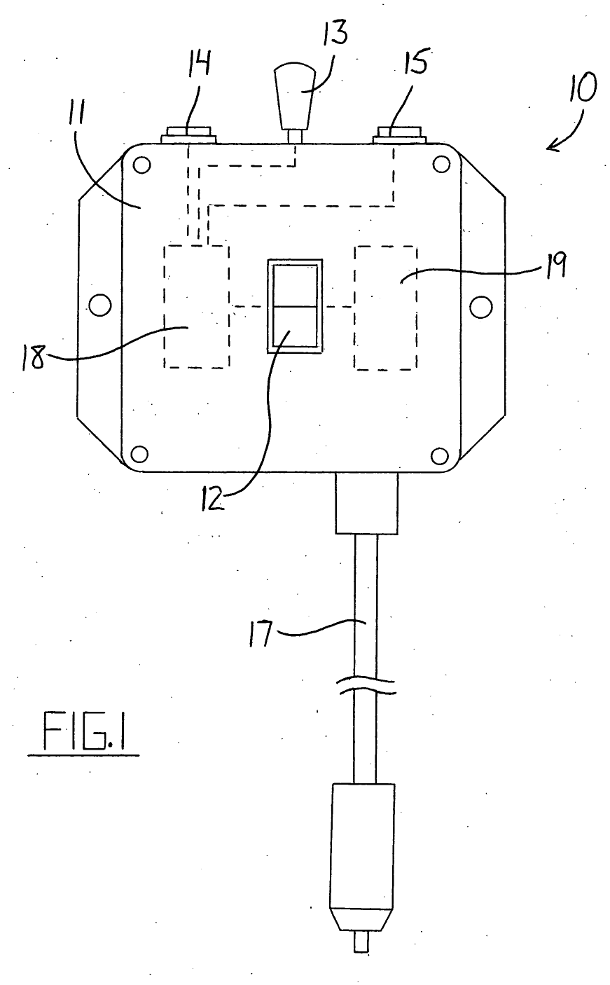

As shown by hidden lines in FIG. 1, a control unit 18 and a transmitter 19 are disposed within the box 11 of the transmitter unit 10. The control unit 18 is operably connected to the joystick 13 and two buttons 14, 15 to receive signals therefrom and send appropriate output to the transmitter 19. A receiver 30 within the box 21 of the receiver unit 20 receives an output signal from the transmitter 19 by means of the antenna 26. A second control unit 29, also disposed within the box 21, is operably connected between the receiver 30 and the array of lights 22 and beeper 23. This control unit 29 controls the visual and audible output of the array of lights and beeper of the receiver unit 20 based on the specific signal received from the transmitter unit 10.

When the joystick on the transmitter is pushed forward, the receiver unit in the truck beeps, and the lights of the central set and the forward set are illuminated indicating in effect a forward arrow on the array of lights, signaling the driver to move ahead. The arrow stays on as long as the transmitter's joystick switch is held in position. The same occurs in all four directions with the receiver unit emitting a distinct beep for each direction. When the transmitter's STOP button/switch is pressed, the receiver beeps and all the lights on the array start flashing, signaling the driver to stop. When the transmitter's FULL or GO button/switch is pressed, the receiver beeps, and the array of lights creates a wheel rolling effect, providing to the person at the receiving unit an indication of GO signaling to the truck operator that the box is full and that the truck should thus depart.

The units have a channel selector dial on the receiver which is used when two or more transmitters are being used in the same field. The transmitters are all set to a different channel so they do not interfere with one another. The units have eight channels. The transmitter's channel can be programmed with the buttons and joystick such that there is no need to open the box.

The transmitter unit can be mounted in different positions and orientations, in this example, in the potato harvester. As a result, the transmitter unit can be programmed as to its orientation in order to define which directional movement of the joystick will indicate forward on the receiver unit. The orientation of the transmitter unit can be programmed with the on/off switch and joystick.

The communicator has a range of approximately 50 meters.

The advantages with using the Communicator are these:

When digging potatoes the operator is required to keep his hands as close to the harvester controller as possible, to provide proper control to prevent plugging. The arrangement described herein allows the user to locate the transmitter as close as possible to the harvester controller.

The display uses arrows, which is in effect a universal language. So that if the persons concerned have little common language skills, there is no problem communicating between them.

2-way radios often have interference from others using them at the same time and the message may not be transferred on time, or the wrong drivers might follow instructions. With the device as described herein there is a dedicated channel for every harvester (up to 8), and the driver selects which harvester he/she is communicating with.

The device can be used for any other harvesting operation, and even for guiding for unloading. It can also be used for other applications (cranes, cement mixers, forklifts and forestry just to name a few).

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Communication apparatus for communicating instructions from a first vehicle to a second vehicle comprising:
a transmitting unit comprising:
a transmitter housing which can be readily moved from site to site;
the housing having a fastening arrangement by which it can be fastened to a suitable support surface in a cab of the first vehicle;
the housing having mounted thereon at a position for access by an operator of the first vehicle a manually graspable control switch having four different positions each indicative of a respective one of four different directions which can be selected by the operator;
a transmitter for transmitting a signal indicative of the direction selected;
and a separate receiving unit comprising:
a housing which can be readily moved from site to site for location at a receiving site different from the transmitting unit;
the housing having a fastening arrangement by which it can be fastened to a suitable support surface in a cab of the first vehicle;
a receiver for receiving the transmitted signal;
and a display on the housing responsive to operation of the control switch and having a plurality of different directions which can be displayed such that when the operator selects one of the directions and operates the control switch accordingly the respective direction is displayed on the display for viewing by a person at the receiving site.

2. The apparatus according to claim 1 wherein the control switch and the display have four directions which are forward, backward, left side and right side.

3. The apparatus according to claim 1 wherein the display is illuminated.

4. The apparatus according to claim 1 wherein the display is formed of a plurality of LEDs arranged in an array.

5. The apparatus according to claim 1 wherein the transmitter includes a first button and a second button which are operable separately from the control switch and which provide operation of the display different from each other and different from the direction display.

6. The apparatus according to claim 5 wherein the first button indicates STOP and the second button indicates GO.

7. The apparatus according to claim 1 wherein the receiver includes a beeper.

8. The apparatus according to claim 5 wherein the receiver includes a beeper and the sole output of the receiver is the display of the directions and the buttons and the beeper.

9. A method of providing communications of instructions between a first control person at an observation site and a second person at an operating site comprising:
providing at the observation site a transmitting unit comprising:
a housing which can be readily moved from site to site;
a control switch on the housing having a plurality of different directions which are selected by the operator depending on observations at the observation site;
a transmitter for transmitting a signal indicative of a direction selected;
and providing at the operating site a separate receiving unit comprising:
a housing which can be readily moved from site to site for location at a receiving site different from the transmitting unit;
a receiver for receiving the transmitted signal;
and a display on the housing responsive to operation of the control switch and having a plurality of different directions which can be displayed such that when the operator selects one of the directions and operates the control switch accordingly the respective direction is displayed on the display for viewing by a person at the operating site thus providing simple directional instruction to that person.
